(19) United States
(12) Patent Application Publication
(10) Pub. No.: US 2024/0018991 A1
(43) Pub. Date: Jan. 18, 2024

(54) DOUBLE ACTING CAM FASTENER ASSEMBLY

(71) Applicant: Sherex Fastening Solutions LLC, Tonawanda, NY (US)

(72) Inventors: John V. Knechtges, Williamsville, NY (US); Adam D. Pratt, Buffalo, NY (US)

(21) Appl. No.: 18/218,721

(22) Filed: Jul. 6, 2023

Related U.S. Application Data
(60) Provisional application No. 63/388,409, filed on Jul. 12, 2022.

(51) Int. Cl. F16B 39/24; F16B 39/282

(52) U.S. Cl. CPC F16B 39/24; F16B 39/282

(57) ABSTRACT

A fastener comprising a body and a lock washer to be positioned between the body and a work surface, the washer having a plurality of circumferentially spaced cam surfaces, each being inclined relative to a plane normal to the center axis within a cam radial angle, alternating circumferentially about the center axis with a plurality of circumferentially spaced slip surfaces, each being inclined relative to the plane within a slip radial angle, each of the cam surfaces intersecting with two adjacent slip surfaces at a radial ridge and a radial valley, wherein the cam radial angle is greater than the slip radial angle and a radial angle ratio between the cam and slip radial angles is less than or equal to about 4.5, and the ridge having a ridge height relative to the valley greater than or equal to about 0.08 mm.

### TECHNICAL FIELD

The present invention relates generally to the field of fasteners, and more particularly to an improved fastener for applications under vibration.

### BACKGROUND ART

U.S. Pat. No. 5,080,545 is directed to a lock washer assembly having wedge lock action in which two washers are used in back-to-back relation with one face of each washer serrated to form a series of circumferentially extending cam surfaces that when arranged between a work piece and a fastener element act as a wedge lock device.

U.S. Pat. No. 8,899,895 is directed to an anti-back-out fastener for use in a high vibration application. The fastener includes a nut having both a body with wedge locking action fastening features and a locking washer with matching wedge locking action fastening features to the wedge locking action fastening features of the body.

### BRIEF SUMMARY

With parenthetical reference to the corresponding parts, portions or surfaces of the disclosed embodiment, merely for purposes of illustration and not by way of limitation, an improved fastener assembly (15, 115) is provided comprising: an elongated fastener body (20, 120) orientated about a rotational axis (16); the fastener body having a threaded section (21, 121) orientated about the rotational axis; the fastener body having an externally and radially extending bearing portion (22, 122) operatively configured to be axially retained by a work surface (19); the bearing portion having an inner head surface (23, 123), an outer head peripheral edge (24, 124), and an inner head peripheral edge (25, 125); an annular lock washer (50, 150, 250) operatively configured to move axially and rotationally relative to the bearing portion and to be positioned between the inner head surface of the bearing portion and the work surface; the annular lock washer having an inner washer surface (53, 153, 253), an outer washer peripheral edge (54, 154, 254), an inner washer peripheral edge (55, 155, 255), and an outer washer surface (56, 156, 256); the inner washer surface comprising a plurality of circumferentially spaced washer cam surfaces (60, 160) extending radially between the inner washer peripheral edge and the outer washer peripheral edge; each of the washer cam surfaces being inclined relative to an imaginary plane (17) orientated normal to the rotational axis from a lower washer cam edge (61, 161) to an upper washer cam edge (62, 162) within a washer cam radial angle (63); the inner washer surface comprising a plurality of circumferentially spaced washer slip surfaces (65, 165) extending radially between the inner washer peripheral edge and the outer washer peripheral edge; each of the washer slip surfaces being inclined relative to the imaginary plane orientated normal to the rotational axis from a lower washer slip edge (66, 166) to an upper washer slip edge (67, 167) within a washer slip radial angle (68); the plurality of circumferentially spaced washer cam surfaces (60a, 60b, 160) alternating circumferentially about the rotational axis with the plurality of circumferentially spaced washer slip surfaces (65a, 65b, 65c, 165); each of the washer cam surfaces (60a, 160) intersecting with two adjacent washer slip surfaces (65a, 65b, 165) at a radial washer ridge (70a, 170) defined by the upper washer cam edge (62a, 162) of the washer cam surface and the upper washer slip edge (67a, 167) of a first of the two adjacent washer slip surfaces and a radial washer valley (71a, 171) defined by the lower washer cam edge (61a, 161) of the washer cam surface and the lower washer slip edge (66b, 166) of a second of the two adjacent washer slip surfaces; the washer cam radial angle being greater than the washer slip radial angle; the washer cam surface and the washer slip surface having a washer radial angle ratio between the washer cam radial angle and the washer slip radial angle (63/68) that is less than or equal to about 4.5; and the radial washer ridge having a ridge height (72) normal to the imaginary plane and relative to the radial washer valley that is greater than or equal to about 0.08 mm.

The inner head surface may comprise a plurality of circumferentially spaced head cam surfaces (30, 130) extending radially between the inner head peripheral edge and the outer head peripheral edge; each of the head cam surfaces may be inclined relative to the imaginary plane orientated normal to the rotational axis from a lower head cam edge (31, 131) to an upper head cam edge (32, 132) within a head cam radial angle (33); the inner head surface may comprise a plurality of circumferentially spaced head slip surfaces (35, 135) extending radially between the inner head peripheral edge and the outer head peripheral edge; each of the head slip surfaces being inclined relative to the imaginary plane orientated normal to the rotational axis from a lower head slip edge (36, 136) to an upper head slip edge (37, 137) within a head slip radial angle (38); the plurality of circumferentially spaced head cam surfaces (30a, 30b, 130) alternating circumferentially about the rotational axis with the plurality of circumferentially spaced head slip surfaces (35a, 35b, 35c, 135); each of the head cam surfaces (30a, 130) intersecting with two adjacent head slip surfaces (35a, 35b, 135) at a radial head ridge (40a, 140) defined by the upper head cam edge (32a, 132) of the head cam surface and the upper head slip edge (37a, 137) of a first of the two adjacent head slip surfaces and a radial head valley (41a, 141) defined by the lower head cam edge (31a, 131) of the head cam surface and the lower head slip edge (36b, 136) of a second of the two adjacent head slip surfaces; the head cam radial angle may be greater than the head slip radial angle; the head cam surface and the head slip surface may have a head radial angle ratio between the head cam radial angle and the head slip radial angle (33/38) that is less than or equal to about 4.5; and the radial head ridge may have a ridge height (42) normal to the imaginary plane and relative to the radial head valley that is greater than or equal to about 0.08 mm. The washer cam radial angle and the head cam radial angle may be substantially equal. The washer slip radial angle and the head slip radial angle may be substantially equal.

The outer washer surface (56, 156, 256) may comprise a plurality of circumferentially spaced first teeth (80, 180) operatively configured to resist rotation of the washer in a first rotational direction about the rotational axis relative to the work surface under an applied axial load; and the outer washer surface may comprise a plurality of circumferentially spaced second teeth (85, 185) operatively configured to resist rotation of the washer in a second rotational direction about the rotational axis relative to the work surface under an applied axial load. The plurality of circumferentially spaced first teeth may extend radially between the inner washer peripheral edge and the outer washer peripheral edge; and the plurality of circumferentially spaced second teeth may extend radially between the inner washer peripheral edge and the outer washer peripheral edge. Each of the plurality of circumferentially spaced first teeth may comprise a first bite edge surface (81, 181) orientated perpendicular to the imaginary plane orientated normal to the rotational axis; each of the plurality of circumferentially spaced first teeth may comprise a first back surface (82, 182) being inclined relative to the imaginary plane orientated normal to the rotational axis within a first back radial angle (83) and intersecting the first bite edge surface; each of the plurality of circumferentially spaced second teeth may comprise a second bite edge surface (86, 186) orientated perpendicular to the imaginary plane orientated normal to the rotational axis; each of the plurality of circumferentially spaced second teeth may comprise a second back surface (87, 187) being inclined relative to the imaginary plane orientated normal to the rotational axis within a second back radial angle (88) and intersecting the second bite edge surface; the plurality of circumferentially spaced first teeth may alternate circumferentially about the rotational axis with the plurality of circumferentially spaced second teeth; each of the first back surfaces (82, 182) of the first plurality of circumferentially spaced first teeth may intersect with an adjacent second back surface (87, 187) of the second plurality of circumferentially spaced second teeth at a radial back valley (90, 190); and each of the first bite edge surfaces (81, 181) of the first plurality of circumferentially spaced first teeth may be separated from an adjacent second bite edge surface (86, 186) of the second plurality of circumferentially spaced second teeth by a radial bite edge valley surface (91, 191) within an opposed bite edge radial angle (92).

The fastener body may comprise a fastener nut (120) or a fastener bolt (20). The fastener body may be in the form of a bolt (20) and comprise: a head portion (27) having an outer head surface and comprising the inner bearing portion (22); a shank portion (21) extending axially from the inner head peripheral edge (25) of the inner bearing portion and operatively configured to extend through the work surface; the shank portion comprising the threaded section, which is orientated externally about the rotational axis; and the annular lock washer (50) operatively configured to receive the shank portion of the fastener body. The head portion of the bolt may comprise a hexagonal outer surface or a round outer surface with an internal drive recess. The fastener body may be in the form of a nut (120) and may comprise: a head portion (127) having an outer head surface and comprising the inner bearing portion (122); a washer retaining portion (144) extending axially from the inner head peripheral edge (125) of the inner bearing portion; the head portion comprising the threaded section (121), which is orientated internally about the rotational axis; and the annular lock washer (150) operatively configured to receive the washer retaining portion of the fastener body. A portion of the washer retaining portion may be crimped over a portion of the outer washer surface (156). The head portion of the nut may comprise a hexagonal outer surface or a round outer surface with an internal drive recess.

The outer washer peripheral edge (254) of the annular lock washer (250) may be axially offset (95) from the inner washer peripheral edge (255) of the annular lock washer, whereby the annular lock washer has a conical form prior to an applied axial load. The threaded section of the fastener body may have a thread (28, 128) having a pitch angle (49), each of the head cam surfaces may be operatively configured to be in sliding contact with one of each of the washer cam surfaces, within an angular range of relative rotational motion (60) about the rotational axis, on contact planes (46) that are each inclined at a contact angle (47) relative to the imaginary plane, and each contact angle may be greater than the pitch angle. The angular range of relative rotational motion about the rotational axis may be substantially equal to the washer cam radial angle. The threaded section of the fastener body may have a thread having a pitch distance (29, 129) and the ridge height of the radial washer ridge may be less than the pitch distance.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a view illustrating a first embodiment of an improved fastener assembly being tightened on a workpiece.

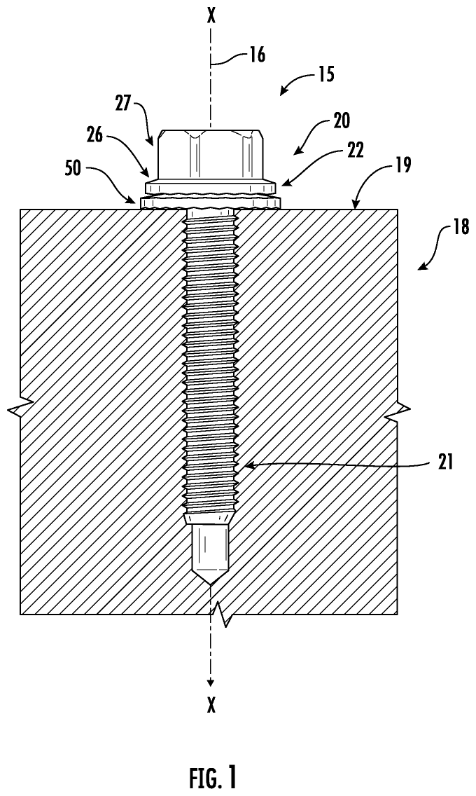

FIG. 2 is a top perspective view of the fastener assembly shown in FIG. 1.

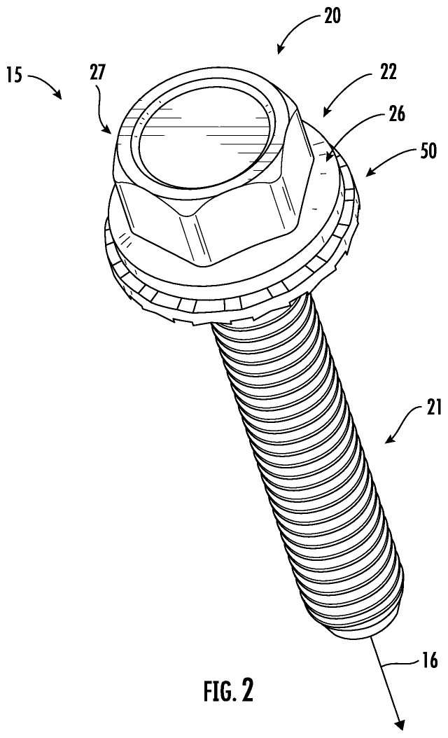

FIG. 3 is a bottom perspective view of the fastener assembly shown in FIG. 2.

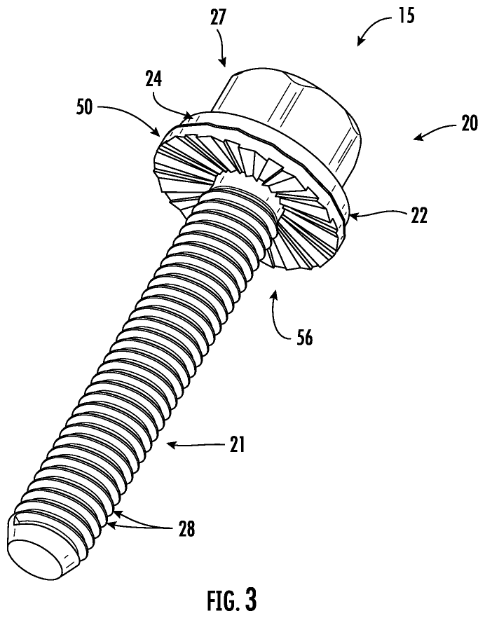

FIG. 4 is an enlarged side perspective view of the fastener assembly shown in FIG. 2.

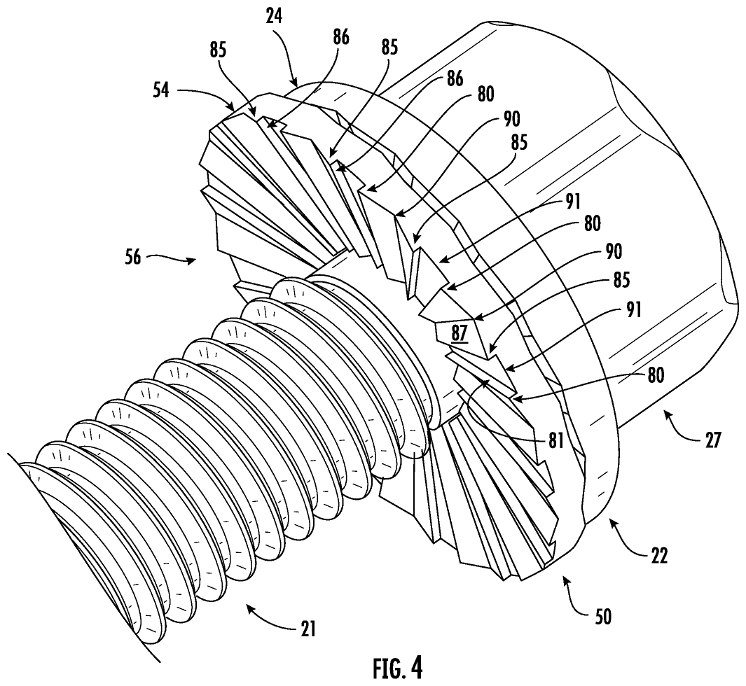

FIG. 5 is a top perspective view of the washer shown in FIG. 2.

FIG. 6 is top perspective view of the washer shown in FIG. 5 with cam surfaces emphasized.

FIG. 7 is a top perspective view of the washer shown in FIG. 5 with slip surfaces emphasized.

FIG. 8 is a top plan view of the washer shown in FIG. 5.

FIG. 9 is a side plan view of the washer shown in FIG. 5.

FIG. 10 is a partialized perspective view of the washer shown in FIG. 5.

FIG. 11 is an enlarged perspective view of the partial washer piece shown in FIG. 10.

FIG. 12 is a side view of the partial washer piece shown in FIG. 11.

FIG. 13 is a bottom perspective view of the washer shown in FIG. 2.

FIG. 14 is a bottom plan view of the washer shown in FIG. 13.

FIG. 15 is a bottom perspective view of the bolt shown in FIG. 2.

FIG. 16 is an enlarged side perspective view of the bolt shown in FIG. 15 with a cam surface emphasized.

FIG. 17 is an enlarged side perspective view of the bolt shown in FIG. 15 with a slip surface emphasized.

FIG. 18 is a bottom plan view of the bolt shown in FIG. 15.

FIG. 19 is a partialized perspective view of the bolt shown in FIG. 15.

FIG. 20 is an enlarged side view of the partial bolt piece shown in FIG. 19.

FIG. 21 is a partial sectional view of locking camming contact between cam surfaces of the washer and fastener body shown in FIG. 1.

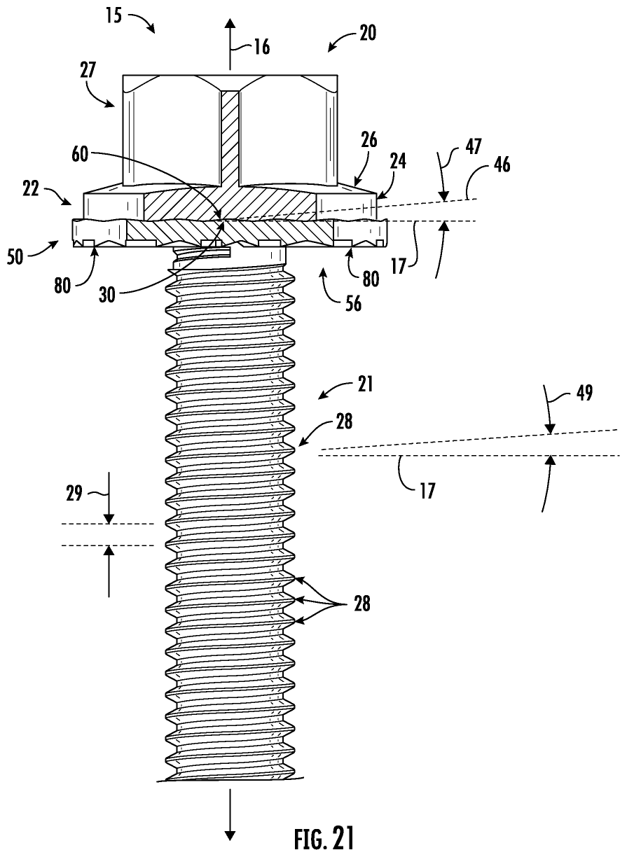

FIG. 22 is a top perspective view of a second embodiment of an improved fastener assembly.

FIG. 23 is a bottom perspective view of the fastener assembly shown in FIG. 21.

FIG. 24 is an exploded perspective view of the fastener assembly shown in FIG. 22.

FIG. 25 is a top perspective view of the washer shown in FIG. 23.

FIG. 26 is a bottom perspective view of the washer shown in FIG. 24.

FIG. 27 is a side view of an alternate embodiment of the washer shown in FIG. 5.

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., crosshatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

It is to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

It is to be appreciated that the present teaching is by way of example only, not by limitation. The concepts herein are not limited to use or application with a specific system or method. Thus, although the instrumentalities described herein are for the convenience of explanation, shown and described with respect to exemplary embodiments, it will be appreciated that the principles herein may be applied equally in other types of systems and methods involving fastener assemblies.

Where they are used herein, the terms “first,” “second,” and so on, do not necessarily denote any ordinal, sequential, or priority relation, but are simply used to more clearly distinguish one element or set of elements from another, unless specified otherwise.

To the extent that the definitions provided above are consistent with ordinary, plain, and accustomed meanings (as generally evidenced, in alia, by dictionaries and/or technical lexicons), the above definitions shall be considered supplemental in nature. To the extent that the definitions provided above are inconsistent with ordinary, plain, and accustomed meanings (as generally evidenced, inter alia, by dictionaries and/or technical lexicons), the above definitions shall control. If the definitions provided above are broader than the ordinary, plain, and accustomed meanings in some aspect, than the above definitions will control at least in relation to their broadening aspects.

Referring now to the drawings, an improved fastener assembly is provided, a first bolt-type embodiment of which is generally indicated at 15. Fastener assembly 15 broadly includes elongated fastener body 20 orientated about rotational axis 16 and annular cam washer 50 orientated about rotational axis 16.

Fastener body 20 is shown as being a horizontally-elongated specially-configured tubular member orientated about axis 16 and generally comprising upper tool-engaging hexagonal head portion 27, intermediate bearing portion 22, and lower threaded shank portion 21 on which washer 50 is rotationally and concentrically supported.

Hex portion 27 is configured to be received in a corresponding hex socket, tool, or drive surface of a drive tool such that a driving torque may be applied to fastener body 20 about axis 16. Alternatively, the head portion may have a round outer surface with an internal drive recess or socket configured to receive a corresponding ratchet drive or drive surface of a drive tool such that a driving torque may be applied to fastener body 20 about axis 16. Other drive configurations may be used as further alternatives. As shown, shank portion 21 is a solid cylindrical shaft orientated about axis 16 that is externally threaded over a portion or all of its length with continuous helical threads 28 configured to engage work piece 18 on which fastener body 20 is to be mounted under an applied driving torque. Bearing portion 22 of bolt fastener 20 extends radially from head portion 27 about axis 16 and is generally bounded by upwardly-facing annular surface 26, outwardly-facing cylindrical surface 24, and downwardly-facing specially-configured annular surface or face 23, joined at its inner marginal edge 25 to the upper marginal end of shank 21.

Downwardly-facing annular surface 23 of bearing portion 22 is adapted to face toward and be axially retained by wall surface 19 with cam washer 50 acting therebetween. As shown, upwardly-facing annular surface 53 of washer 50 is adapted to face toward and slidingly engage downwardly-facing annular surface 23 of fastener body 20 and downwardly-facing annular surface 56 of washer 50 is adapted to face toward and rotationally engage outer work surface 19 of work piece 18 about and immediately adjacent shank 21 of fastener body 20.

Cam washer 50 is positioned on threaded shank 21 of bolt 20, which is secured to workpiece 18 via threads 28. A wrench or other tool is used for tightening fastener 20 via hex head 27 in the clockwise direction to apply an axial load on workpiece 18 via bearing portion 22. The wrench or other tool is rotated in the opposite direction for loosening fastener 20 and releasing the axial load on workpiece 18.

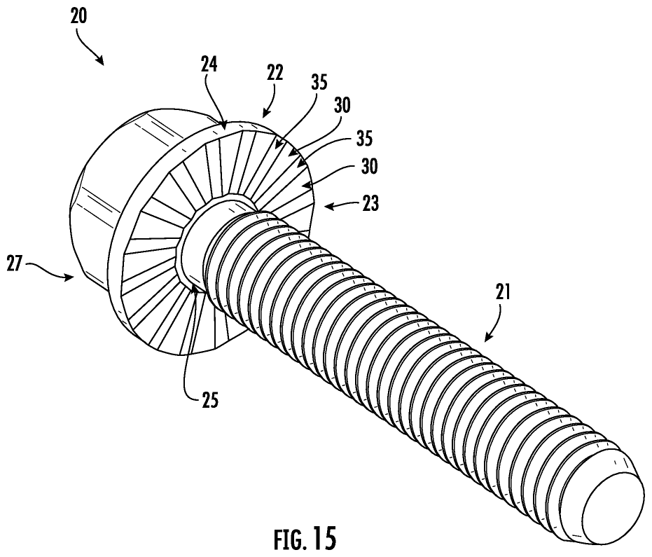

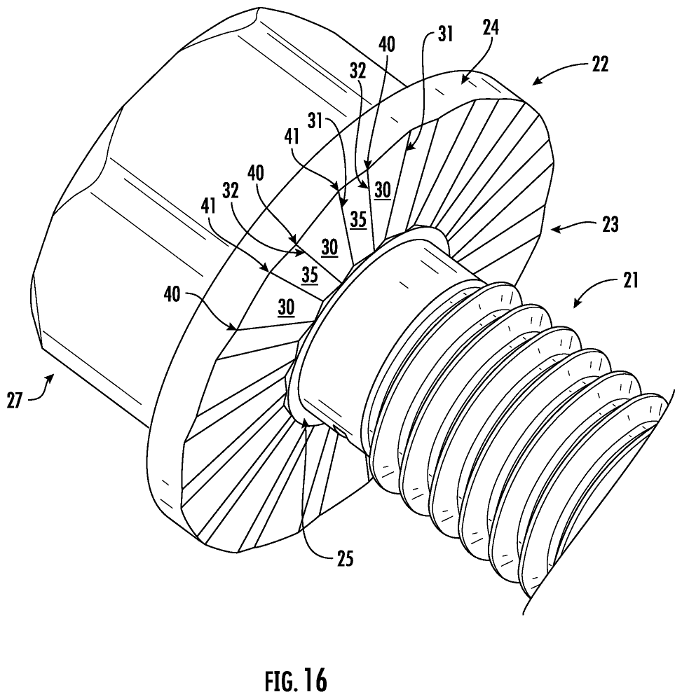

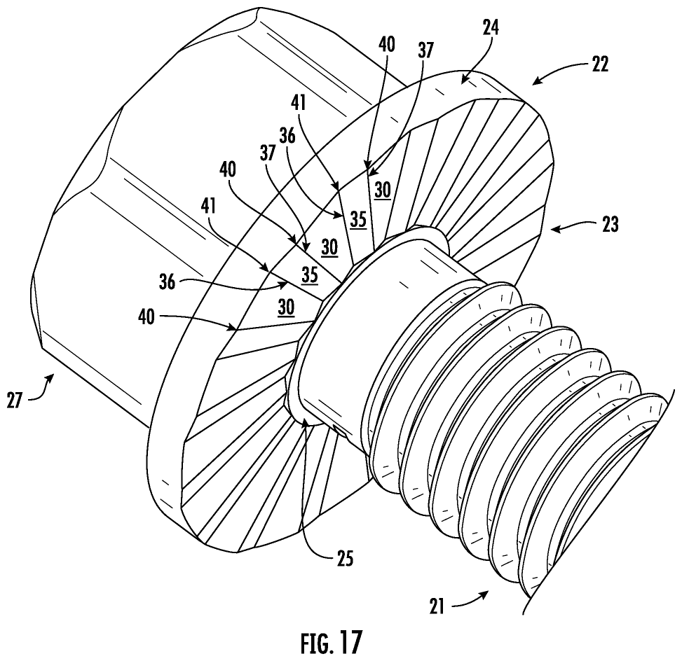

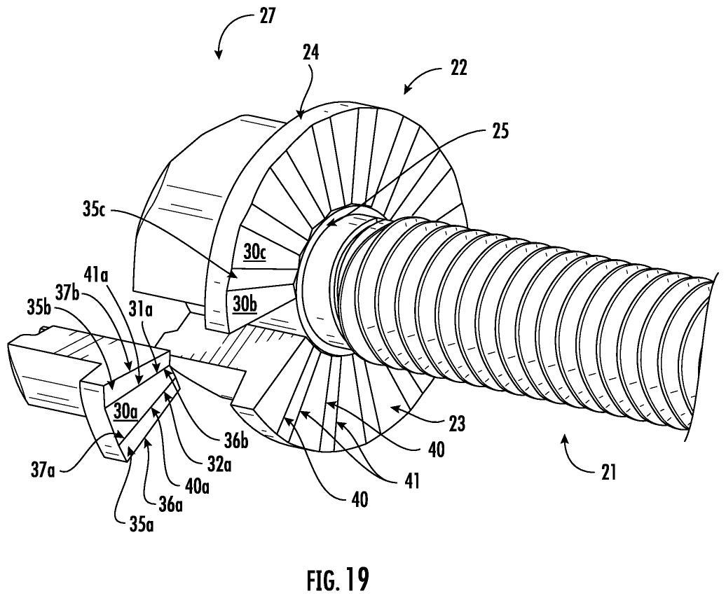

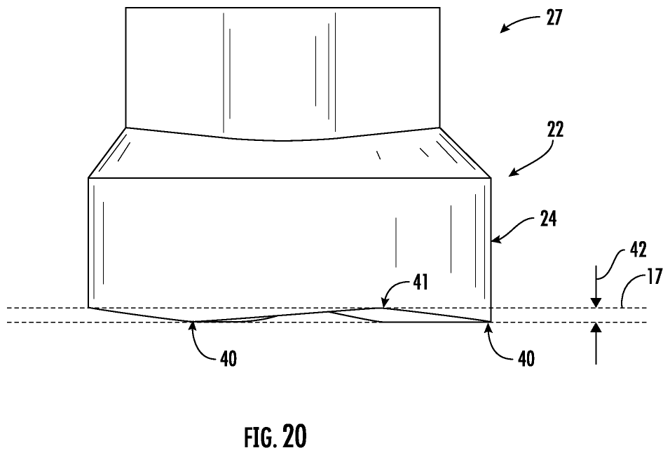

FIGS. 15-20 show bolt 20. Annular face 23 of bearing portion 22 of bolt 20 is specially configured to provide an improved cam functionality in conjunction with opposed face 53 of washer 50. As shown, face 23 of bearing portion 22 of bolt 20 includes a plurality of circumferentially spaced cam surfaces, severally indicated at 30, extending radially within a cam radial angle 33 between, at least partially, inner edge 25 and outer cylindrical surface 24. Each of cam surfaces 30 are inclined relative to imaginary plane 17 orientated normal to rotational axis 16 from lower cam edges 31 to upper cam edges 32, respectively. Face 23 also includes a plurality of circumferentially spaced slip surfaces, severally indicated at 35, extending radially within a slip radial angle 38 between, at least partially, inner cylindrical edge 25 and outer cylindrical surface 24. Each of slip surfaces 35 are inclined relative to imaginary plane 17 from lower slip edges 36 to upper slip edges 37, respectively. As shown, the plurality of circumferentially spaced cam surfaces 30 alternate circumferentially about rotational axis 16 with the plurality of circumferentially spaced slip surfaces 35 and are inclined relative to the plurality of circumferentially spaced slip surfaces 35 such that each cam surface 30 intersects with two adjacent slip surfaces 35 at radially-extending ridge 40 on one radial side and at radially-extending valley 41 at the other radial side. As shown, cam radial angle 33 is greater than slip radial angle 38. In this embodiment, the radial angle ratio 33/38 of the cam radial angle 33 over the slip radial angle 38 is less than or equal to about 4.5 and greater than about 1. As shown in FIG. 20, in a plane normal to imaginary plane 17, radially-extending ridge 40 has height 42 relative to radially-extending valley 41. In this embodiment, height 42 is about 0.08 mm or greater.

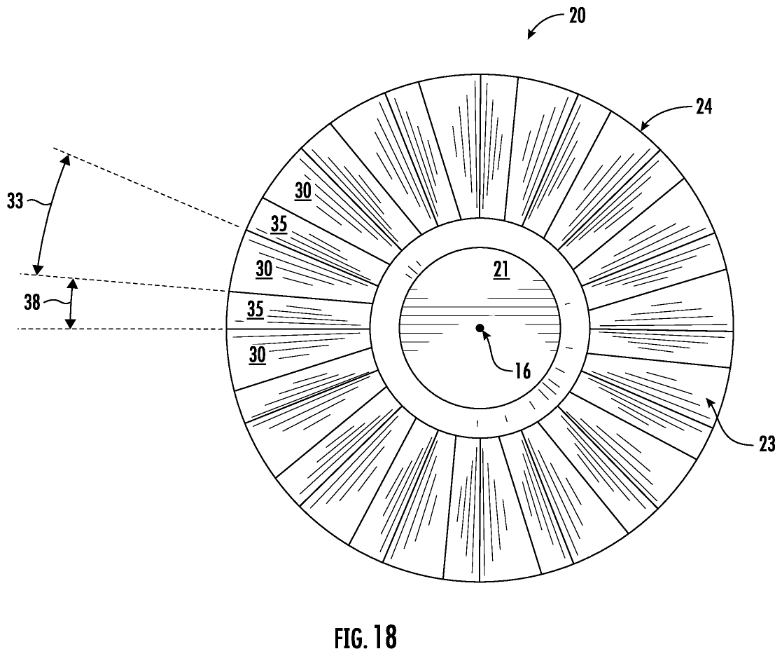

Thus, with reference to FIGS. 18-20 in particular and as a representative example of the configuration of each alternating cam surface 30 and slip surface 35 defining face 23, cam surface 30a extends radially within cam radial angle 33 at least partially between inner circular edge 25 and outer cylindrical surface 24 of bearing portion 22 of bolt 20. Cam surface 30a is inclined relative to imaginary plane 17 up from lower cam edge 31a to upper cam edge 32a. Left slip surface 35b extends radially within cam radial angle 38 at least partially between inner circular edge 25 and outer cylindrical surface 24 of bearing portion 22 of bolt 20. Slip surface 35b is inclined relative to imaginary plane 17 down from upper slip edge 37b to lower slip edge 36b. Right slip surface 35a extends radially within cam radial angle 38 at least partially between inner circular edge 25 and outer cylindrical surface 24 of bearing portion 22 of bolt 20. Slip surface 35a is inclined relative to imaginary plane 17 down from upper slip edge 37a to lower slip edge 36a. On one radial side, cam surface 30a intersects with adjacent slip surface 35b at radially-extending valley 41, which is defined by the junction between lower cam edge 31a of cam surface 30a and lower slip edge 36b of left slip surface 35b. On the other radial side, cam surface 30a intersects with the other adjacent slip surface 35a at radially-extending ridge 40, which is defined by the junction between upper cam edge 32a of cam surface 30a and upper slip edge 37a of right slip surface 35a. As shown, radially-extending ridge 40 has height 42 relative to radially-extending valley 41.

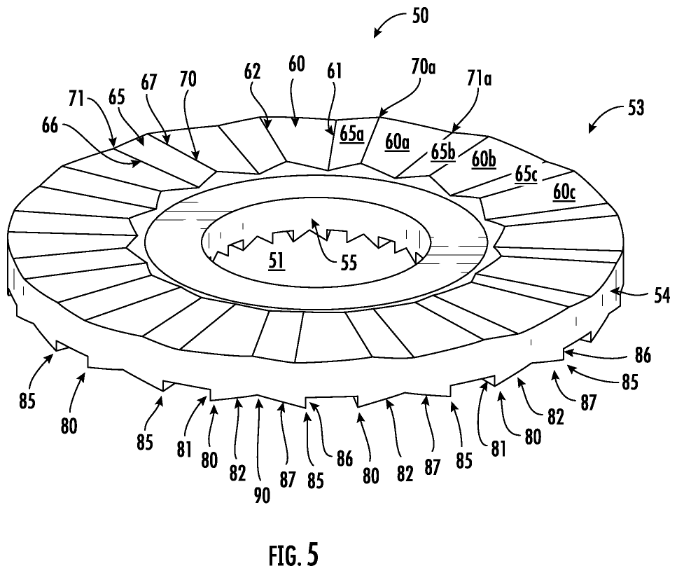

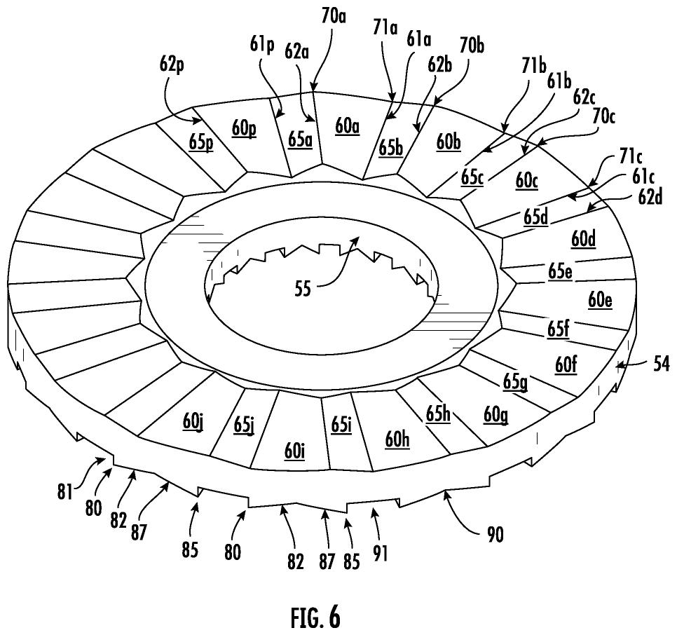

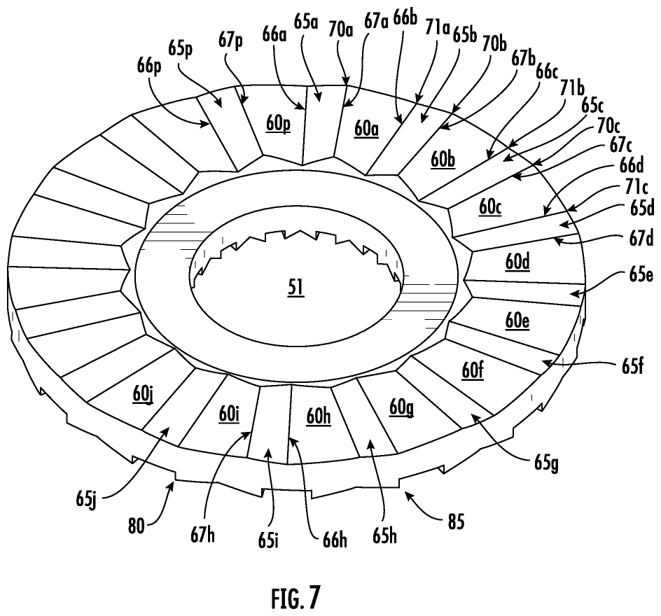

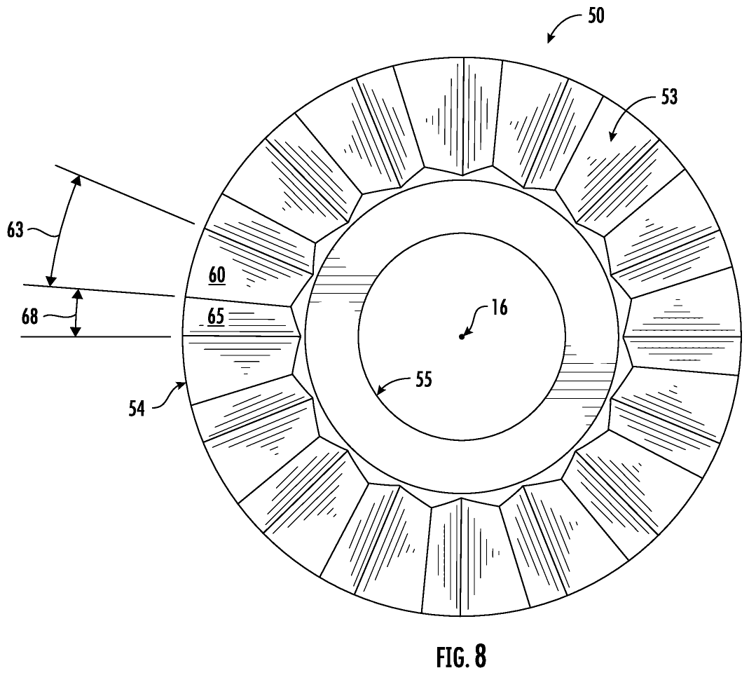

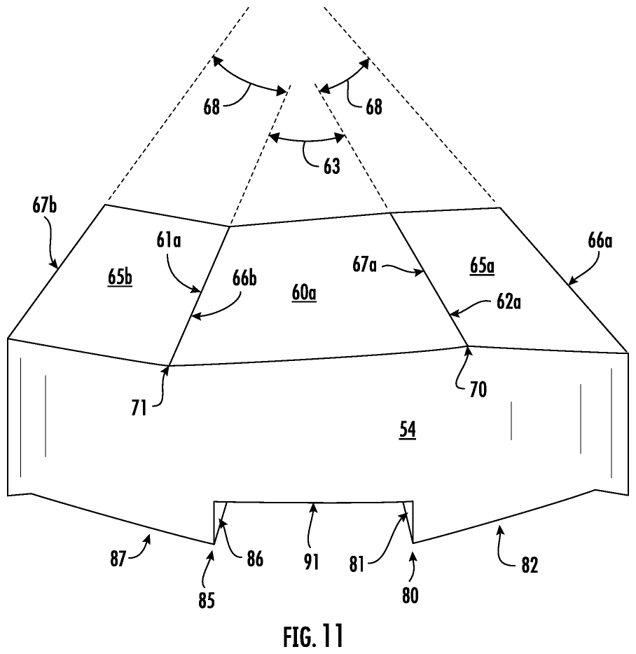

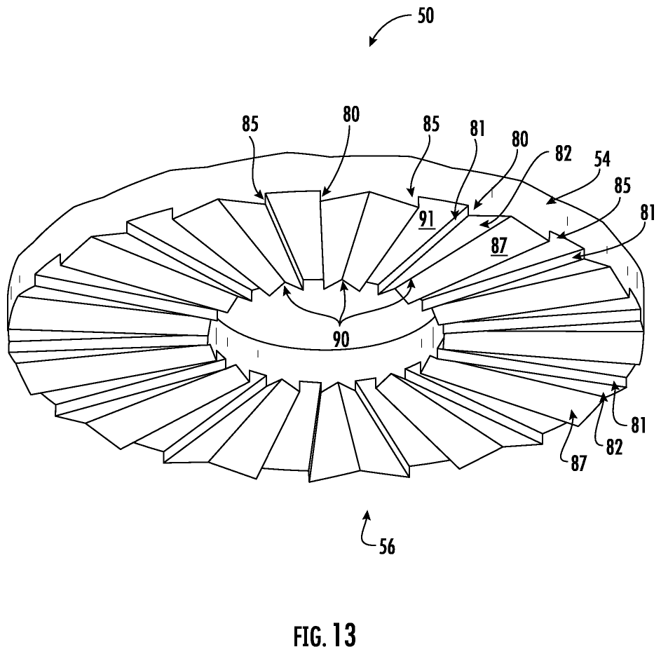

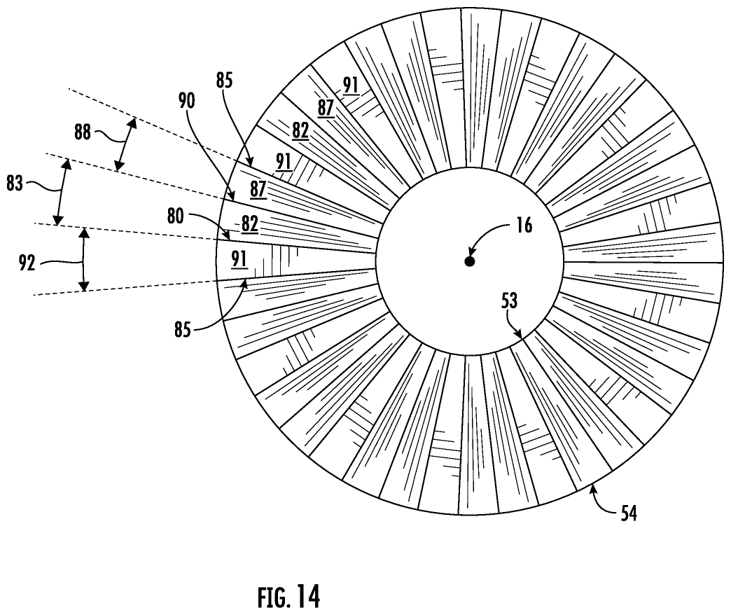

FIGS. 5-14 show cam washer 50. Washer 50 has a generally cylindrical configuration about axis 16 and is generally bounded by upwardly-facing annular surface 53, outwardly-facing cylindrical surface 54, downwardly-facing annular surface 56, and inwardly-facing cylindrical surface 55, defining washer inner opening 51 through which shank 21 is received. Annular lock washer 50 is operatively configured to move axially and rotationally relative to bolt 20 and to be positioned between inner head face 23 of bearing portion 22 and work surface 19.

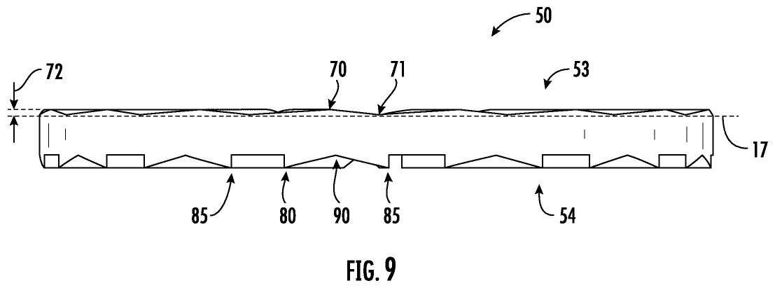

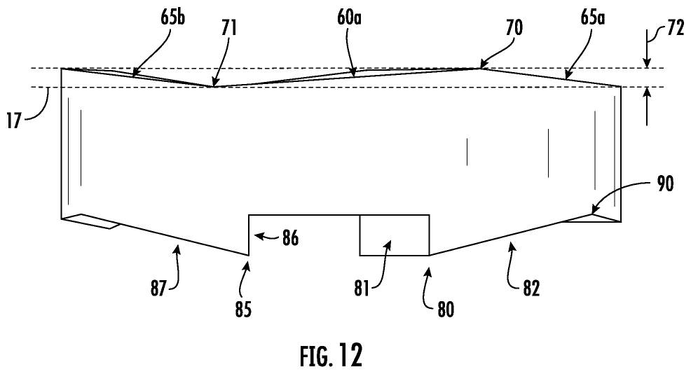

Annular face 53 of washer 50 is specially configured to provide an improved cam functionality in conjunction with opposed face 23 of bearing portion 22 of bolt 20. As shown, face 53 of washer 50 includes a plurality of circumferentially spaced cam surfaces, severally indicated at 60, extending radially within cam radial angle 63 between, at least partially, inner cylindrical surface 55 and outer cylindrical surface 54. Each of cam surfaces 60a-p are inclined relative to imaginary radial plane 17 orientated normal to rotational axis 16 from lower cam edges 61a-p to upper cam edges 62a-p, respectively. Face 53 also includes a plurality of circumferentially spaced slip surfaces, severally indicated at 65, extending radially within slip radial angle 68 between, at least partially, inner cylindrical surface 55 and outer cylindrical surface 54. Each of slip surfaces 65a-p are inclined relative to imaginary plane 17 from lower slip edges 66a-p to upper slip edges 67a-p, respectively. As shown, the plurality of circumferentially spaced cam surfaces 60a-p alternate circumferentially about rotational axis 16 with the plurality of circumferentially spaced slip surfaces 65a-p and are inclined relative to the plurality of circumferentially spaced slip surfaces 65a-p such that each cam surface 60a-p intersects with two adjacent slip surfaces 65a-p at radially-extending ridge 70 on one radial side and at radially-extending valley 71 at the other radial side. As shown, cam radial angle 63 is greater than slip radial angle 68. In this embodiment, the radial angle ratio 63/68 of cam radial angle 63 to slip radial angle 68 is less than or equal to about 4.5 and greater than about 1. As shown in FIGS. 9 and 12, radially-extending ridge 70 has height 72 relative to radially-extending valley 71, in a plane normal to imaginary plane 17. In this embodiment, height 72 is about 0.08 mm or greater.

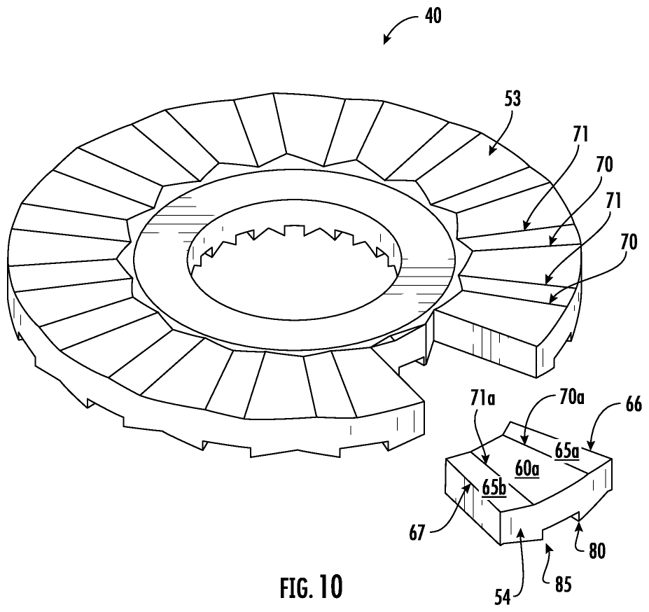

Thus, with reference to FIG. 10-12 in particular and as a representative example of the configuration of each alternating cam surface 60a-p and slip surface 65a-p defining face 53, cam surface 60a extends radially within cam radial angle 63 at least partially between inner cylindrical surface 55 and outer cylindrical surface 54 of washer 50. Cam surface 60a is inclined relative to imaginary plane 17 up from lower cam edge 61a to upper cam edge 62a. Left slip surface 65b extends radially within cam radial angle 68 at least partially between inner cylindrical surface 55 and outer cylindrical surface 54 of washer 50. Slip surface 65b is inclined relative to imaginary plane 17 down from upper slip edge 67b to lower slip edge 66b. Right slip surface 65a extends radially within cam radial angle 68 at least partially between inner cylindrical surface 55 and outer cylindrical surface 54 of washer 50. Slip surface 65a is inclined relative to imaginary plane 17 down from upper slip edge 67a to lower slip edge 66a. On one radial side, cam surface 60a intersects with adjacent slip surface 65b at radially-extending valley 71, which is defined by the junction between lower cam edge 61a of cam surface 60a and lower slip edge 66b of left slip surface 65b. On the other radial side, cam surface 60a intersects with the other adjacent slip surface 65a at radially-extending ridge 70, which is defined by the junction between upper cam edge 62a of cam surface 60a and upper slip edge 67a of right slip surface 65a. As shown, radially-extending ridge 70 has height 72 relative to radially-extending valley 71.

Face 56 of washer 50 is also configured to provide improved cam functionality in conjunction with opposed surface 19 of work piece 18. Face 56 of washer 50 has a plurality of equally circumferentially spaced and radially extending seizing teeth, severally indicated at 80 and 85, configured to engage work surface 19 of work piece 18 under an applied load around face 56 of washer 50. As shown, face 56 includes a plurality of circumferentially spaced teeth 80 operatively configured to resist rotation of washer 50 in a first rotational direction about rotational axis 16 relative to work surface 18 under an applied axial load and a plurality of circumferentially spaced teeth 85 operatively configured to resist rotation of washer 50 in the opposite rotational direction about rotational axis 16 relative to work surface 18 under an applied axial load. Each of teeth 80 and 85 extend radially between inner cylindrical surface 55 and outer cylindrical surface 54. Each of circumferentially spaced teeth 80 comprise bite edge surface 81 orientated perpendicular to imaginary plane 17 and back surface 82 being inclined relative to imaginary plane 17 within radial angle 83 and intersecting bite edge surface 81. Each of circumferentially spaced teeth 85 comprise bite edge surface 86 orientated perpendicular to imaginary plane 17 and back surface 87 being inclined relative to imaginary plane 17 within radial angle 88 and intersecting bite edge surface 86. Each of back surfaces 82 of circumferentially spaced teeth 80 intersect with an adjacent back surface 87 of circumferentially spaced teeth 85 at radial back valleys 90. Each of edge surfaces 81 of circumferentially spaced teeth 80 are separated from an adjacent bite edge surface 86 of circumferentially spaced teeth 85 by planar edge valley surface 91 within an opposed bite edge radial angle 92. Thus, bite edges 81 face a first rotational direction about axis 16 and bite edges 86 face the opposite rotational direction, with bite edges 81 and 86 opposed to each other across recessed planar surface 91. Accordingly, bite edge 81 of circumferentially spaced teeth 80 will tend to bite into work surface 19 under an applied axial load in a first rotational direction and resist rotation of washer 50 relative to work piece 18 in such rotational direction, and bite edge 86 of circumferentially spaced teeth 85 will tend to bite into work surface 19 under an applied axial load in the opposite rotational direction and resist rotation of washer 50 relative to work piece 18 in such opposite rotational direction.

Accordingly, face 56 of washer 50 includes a plurality of circumferentially spaced bite surfaces, severally indicated at 81, extending radially between inner cylindrical surface 55 and outer cylindrical surface 54, and a plurality of circumferentially spaced back surfaces, severally indicated at 82, extending radially within radial angle 83 between inner cylindrical surface 55 and outer cylindrical surface 54. Each of back surfaces 82 are inclined relative to imaginary plane 17 within radial angle 83 from back valley 90 to the peak of circumferentially spaced teeth respectively. Face 56 also includes a plurality of circumferentially spaced bite surfaces, severally indicated at 86, extending radially between inner cylindrical surface 55 and outer cylindrical surface 54, and a plurality of circumferentially spaced back surfaces, severally indicated at 87, extending radially within radial angle 88 between inner cylindrical surface 55 and outer cylindrical surface 54. Each of back surfaces 87 are inclined relative to imaginary plane 17 within radial angle 88 from back valley 90 to the peak of circumferentially spaced teeth respectively. Face 56 also includes a plurality of circumferentially spaced planar valleys, severally indicated at 91, extending radially within radial angle 92 between inner cylindrical surface 55 and outer cylindrical surface 54. Each of surfaces 91 are on a plane parallel to imaginary plane 17 within radial angle 92 from bite surface 81 to opposed bite surface 86, respectively. As shown, the plurality of circumferentially spaced back surfaces 82 alternate circumferentially about rotational axis 16 with the plurality of circumferentially spaced back surfaces 87, and in turn the opposed pairs of back surfaces 82 and 87 alternate circumferentially about rotational axis 16 with the plurality of circumferentially spaced planar surfaces 91. As shown, radial angles 82, 87 and 91 are generally the same.

Washer 50 has upper cam face 53 which faces toward bolt cam face 23. Washer 50 has central opening 51 which is slidably mounted on shank 21. The opposite face 56 of washer 50 is substantially parallel to cam face 53 and engages work surface 19 of work piece 18 under an applied load. Opening 51 has a diameter which slidably accommodates the diameter of shank 21 but is less than the diameter of bearing portion 22. The diameter of opening 51 of washer 50 is slightly greater than shank 21 so that it abuts portion 22 of bolt 20. Thus, washer 50 is moveable toward intermediate portion 22 to an engaged position in which the cam elements 60 on washer 50 engage the cam elements 30 on bolt 20. In this position, bolt 20 and the washer 50 may be rotated either in an opposite direction, or together in the same direction. Washer 50 is moveable to a separated position in which the cooperating cam elements 40 and 70 clear one another so that bolt 20 can be rotated about axis 16 relative to washer 50 and work piece 18. Each camming end surface 23 and 53 comprises a plural number of circumferentially-spaced cam surfaces 30 and 60 and a corresponding number of interconnecting slip surfaces 35 and 65, respectively. In the illustrated construction, each end face 23 and 53 has twenty-one inclined cam surfaces 30 and 60 and the same number of oppositely inclined slip surfaces 35 and 65, respectively. A greater or lesser number of such surfaces may be used depending on the washer and bolt size.

When tightening bolt 20, bottom face 56 of washer 50 becomes frictionally anchored to surface 19 of associated workpiece 18 via teeth 80. Further rotation of bolt 20 causes slip surfaces 35 of bolt 20 to push slip surfaces 65 of washer 50 until bolt 20 is fully tightened. When bolt 20 is rotated in the loosening or counterclockwise direction, either by vibration or deliberately, bottom face 56 of washer 50 remains frictionally anchored to surface 19 of associated workpiece 18 via teeth 85, while cam surfaces 30 of bolt 20 slide up cam surfaces 60 of washer 50 and bolt 20 moves to a wedged, locked position between cam surfaces 60 of washer and threads 28 on shank 21 of bolt 20. As cam surfaces 30 of bolt 20 slide up corresponding cam surfaces 60 of washer 50, cam surfaces 30 of bolt 20 are in common sliding contact with cam surfaces 60 of washer 50 on contact planes 46 that are inclined at a contact angle 47 relative to imaginary radial plane 17 orientated normal to rotational axis 16, and the contact angle 47 is greater than the pitch angle 49 of threads 28 on shank 21 of bolt 20. Lock action may also be provided by the axial ridge height 42 and 72 dimensions being less than the thread pitch distance 29 of threads 28 on shank 21 of bolt 20.

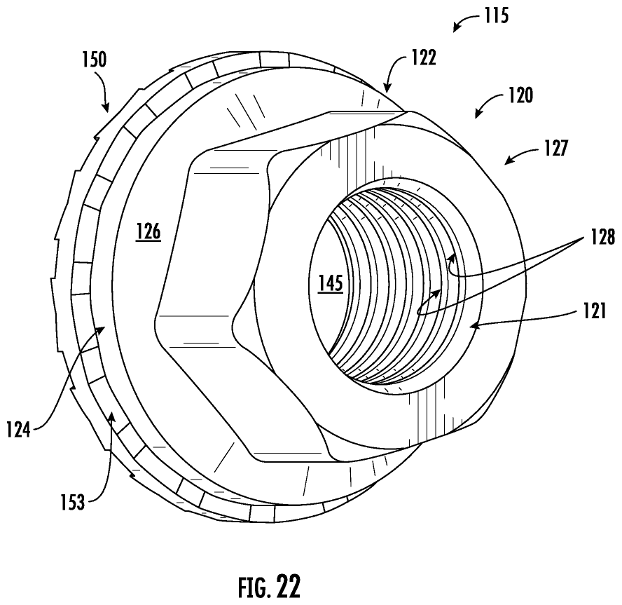

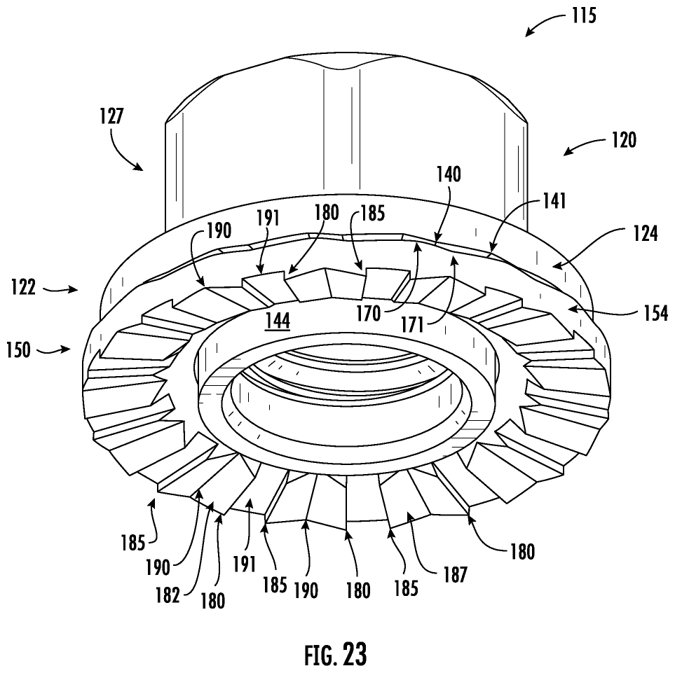

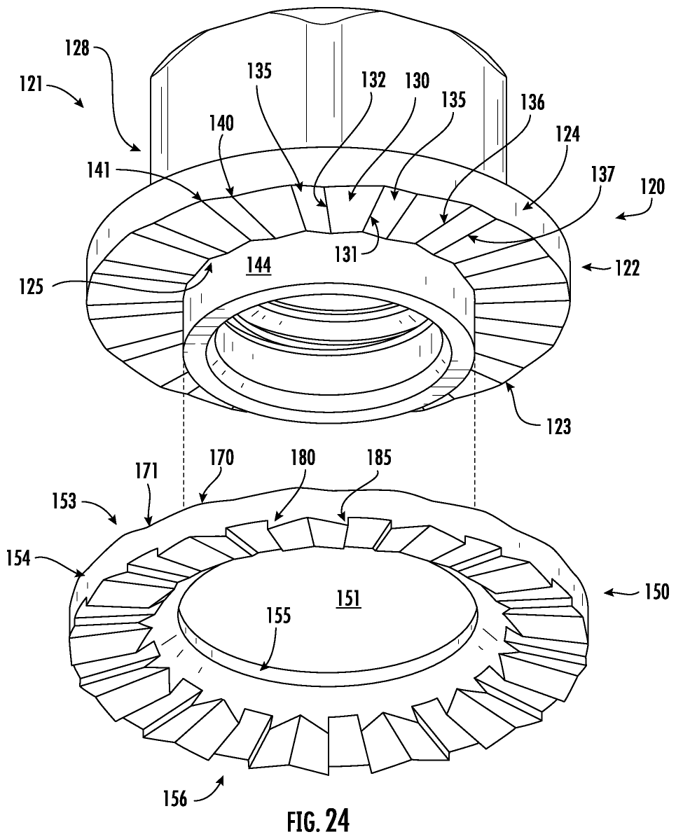

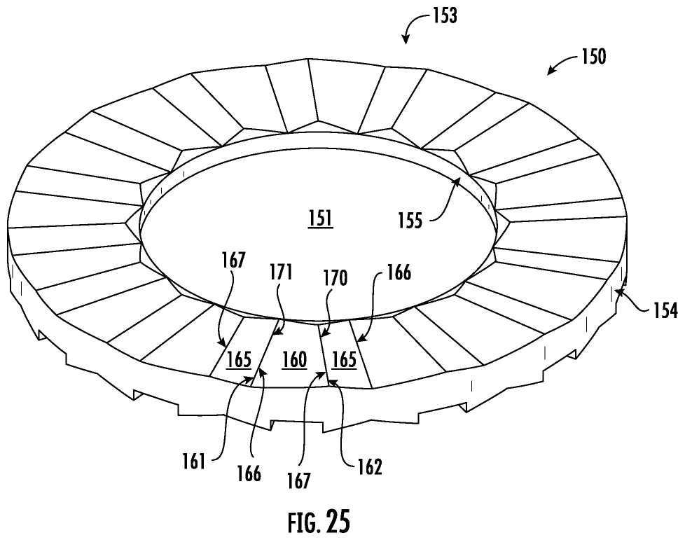

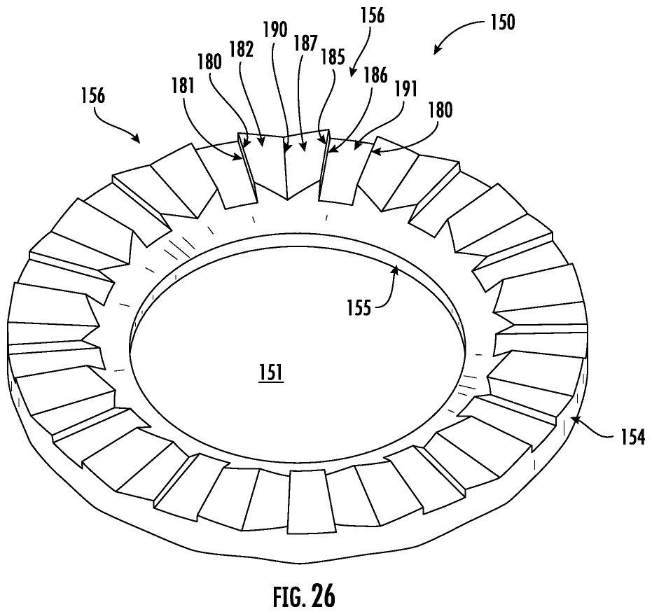

Turning now to FIGS. 22-26, a nut-type fastener assembly 115 according to a second example embodiment is shown. Nut fastener assembly 115 is similar to the above-described bolt fastener assembly 15 with respect to opposed cam faces 123 and 153 of nut 120 and washer 150, respectively, and work piece engaging face 156 of washer 150. Fastener assembly 115 broadly includes elongated fastener body 120 orientated about rotational axis 16 and annular cam washer 150 orientated about rotational axis 16.

Fastener body 120 is shown as being a horizontally-elongated specially-configured cylindrical member orientated about axis 16 and generally comprising upper tool-engaging hexagonal head portion 127, intermediate bearing portion 122, and lower washer retaining portion 144 extending axially from inner peripheral edge 125 of bearing portion 122. In this nut embodiment, head portion 127 of nut fastener 120 includes bore 145 that is internally threaded over a portion or all of its axial length to provide internally threaded section 121, which is orientated internally about rotational axis 16 with internal threads 128. Internally threaded bore 145 of section 121 of nut 120 has a continuous helical thread 128 configured to mate with a correspondingly sized and threaded stud by application of a wrench or other tool to hex-sided head portion 127. In this embodiment, the outer axial portion of washer retaining portion 144 may be radially crimped out over an inner annular portion of outer washer surface 156 to retain washer 150 axially in a first direction while allowing for washer 150 to rotate about axis 16 relative to nut body 120 and move axially in a second direction.

Hex portion 127 is configured to be received in a corresponding hex socket, tool, or drive surface of a drive tool such that a driving torque may be applied to nut 120 about axis 16. Bearing portion 122 of bolt fastener 120 extends radially from head portion 127 about axis 16 and is generally bounded by upwardly-facing annular surface or face 126, outwardly-facing cylindrical surface 124, and downwardly-facing specially-configured annular surface or face 123, joined at its inner marginal edge 125 to the upper marginal end of tubular extension 144. Fastener 120 is adapted to be rotationally mounted such that face 156 abuts surface 19 of work piece 18 to axially retain nut 20 via a stud or other correspondingly threaded member (not shown).

Similar to bolt 20, annular face 123 of bearing portion 122 of nut 120 is specially configured to provide an improved cam functionality in conjunction with opposed face 153 of washer 150. As shown, face 113 of bearing portion 122 of nut 120 includes a plurality of circumferentially spaced cam surfaces, severally indicated at 130, extending radially within cam radial angle 33 between, at least partially, inner edge 125 and outer cylindrical surface 124. Each of cam surfaces are inclined relative to imaginary radial plane 17 orientated normal to rotational axis 16 from lower cam edges 131 to upper cam edges 132, respectively. Face 123 also includes a plurality of circumferentially spaced slip surfaces, severally indicated at 135, extending radially within slip radial angle 38 between, at least partially, inner cylindrical edge 125 and outer cylindrical surface 124. Each of slip surfaces 135 are inclined relative to imaginary plane 17 from lower slip edges 136 to upper slip edges 137, respectively. As shown, the plurality of circumferentially spaced cam surfaces 130 alternate circumferentially about rotational axis 16 with the plurality of circumferentially spaced slip surfaces 135 and are inclined relative to the plurality of circumferentially spaced slip surfaces 135 such that each cam surface 130 intersects with two adjacent slip surfaces 135 at radially-extending ridge 140 on one radial side and at radially-extending valley 141 at the other radial side. In a plane normal to imaginary plane 17, radially-extending ridge 140 has height relative to radially-extending valley 141 of about 0.08 mm or greater.

Like washer 50, washer 150 has a generally cylindrical configuration about axis 16 and is generally bounded by upwardly-facing annular surface 153, outwardly-facing cylindrical surface 154, downwardly-facing annular surface 156, and inwardly-facing cylindrical surface 155, defining washer inner opening 151 through which extension 144 is received. Annular lock washer 150 is operatively configured to move axially and rotationally relative to nut 120 and to be positioned between inner head face 123 of bearing portion 122 and a work surface 19.

Annular face 153 of washer 150 is specially configured to provide an improved cam functionality in conjunction with opposed face 123 of bearing portion 122 of nut 120. As shown, face 153 of washer 150 includes a plurality of circumferentially spaced cam surfaces, severally indicated at 160, extending radially within cam radial angle 63 between, at least partially, inner cylindrical surface 155 and outer cylindrical surface 154. Each of cam surfaces 160 are inclined relative to imaginary radial plane 17 orientated normal to rotational axis 16 from lower cam edges 161 to upper cam edges 162, respectively. Face 153 also includes a plurality of circumferentially spaced slip surfaces, severally indicated at 165, extending radially within slip radial angle 68 between, at least partially, inner cylindrical surface 155 and outer cylindrical surface 154. Each of slip surfaces 165 are inclined relative to imaginary plane 17 from lower slip edges 166 to upper slip edges 167, respectively. As shown, the plurality of circumferentially spaced cam surfaces 160 alternate circumferentially about rotational axis 16 with the plurality of circumferentially spaced slip surfaces 165 and are inclined relative to the plurality of circumferentially spaced slip surfaces 165 such that each cam surface 160 intersects with two adjacent slip surfaces 165 at radially-extending ridge 170 on one radial side and at radially-extending valley 171 at the other radial side. Radially-extending ridge 170 has a height relative to radially-extending valley 171, in a plane normal to imaginary plane 17, of about 0.08 mm or greater.

Face 156 of washer 150 is also configured to provide improved cam functionality in conjunction with opposed surface 19 of work piece 18. Face 156 of washer 150 has a plurality of equally circumferentially spaced and radially extending seizing teeth, severally indicated at 180 and 185, configured to engage work surface 19 of work piece 18 under an applied load around face 156 of washer 150. As shown, face 156 includes a plurality of circumferentially spaced teeth 180 operatively configured to resist rotation of washer 150 in a first rotational direction about rotational axis 16 relative to work surface 18 under an applied axial load and a plurality of circumferentially spaced teeth 185 operatively configured to resist rotation of washer 150 in the opposite rotational direction about rotational axis 16 relative to work surface 18 under an applied axial load. Each of teeth 180 and 185 extend radially between inner cylindrical surface 155 and outer cylindrical surface 154. Each of circumferentially spaced teeth 180 comprise bite edge surface 181 orientated perpendicular to imaginary plane 17 and back surface 182 being inclined relative to imaginary plane 17 within radial angle 83 and intersecting bite edge surface 181. Each of circumferentially spaced teeth 185 comprise bite edge surface 186 orientated perpendicular to imaginary plane 17 and back surface 187 being inclined relative to imaginary plane 17 within radial angle 88 and intersecting bite edge surface 186. Each of back surfaces 182 of circumferentially spaced teeth 180 intersect with an adjacent back surface 187 of circumferentially spaced teeth 185 at radial back valleys 190. Each of edge surfaces 181 of circumferentially spaced teeth 180 are separated from an adjacent bite edge surface 186 of circumferentially spaced teeth 185 by planar edge valley surface 191 within an opposed bite edge radial angle 92. Thus, bite edges 181 face a first rotational direction about axis 16 and bite edges 186 face the opposite rotational direction, with bite edges 181 and 186 opposed to each other across recessed planar surface 191. Accordingly, bite edge 181 of circumferentially spaced teeth 180 will tend to bite into work surface 19 under an applied axial load in a first rotational direction and resist rotation of washer 150 relative to work piece 18 and bite edge 186 of circumferentially spaced teeth 185 will tend to bite into work surface 19 under an applied axial load in the opposite rotational direction and resist rotation of washer 150 relative to work piece 18. Each of back surfaces 182 are inclined relative to imaginary plane 17 within radial angle 83 from back valley 190 to the peak of circumferentially spaced teeth 180, respectively, and each of back surfaces 187 are inclined relative to imaginary plane 17 within radial angle 88 from back valley 190 to the peak of circumferentially spaced teeth 185, respectively.

Washer 150 has upper cam face 153 which faces toward nut cam face 123. Washer 150 has central opening 151 which is slidably mounted on extension 144. The opposite face 156 of washer 150 is substantially parallel to cam face 153 and engages work surface 19 of work piece 18 under an applied load. Opening 151 has a diameter which slidably accommodates the diameter of extension 144 but is less than the diameter of bearing portion 122. The diameter of opening 151 of washer 150 is slightly greater than extension 144 so that it abuts portion 122 of nut 120. Thus, washer 150 is moveable toward intermediate portion 122 to an engaged position in which the cam elements 160 on washer 150 engage the cam elements 130 on nut 120. In this position, nut 120 and the washer 150 may be rotated either in an opposite direction, or together in the same direction. Washer 150 is moveable to a separated position in which the cooperating cam elements 140 and 170 clear one another so that nut 120 can be rotated about axis 16 relative to washer 150 and work piece 18. Each camming end surface 123 and 153 comprises a plural number of circumferentially-spaced cam surfaces 130 and 160 and a corresponding number of interconnecting slip surfaces 135 and 165, respectively.

When tightening nut 120, bottom face 156 of washer 150 becomes frictionally anchored to surface 19 of associated workpiece 18 via teeth 180. Further rotation of nut 120 causes slip surfaces 135 of nut 120 to push slip surfaces 165 of washer 150 until nut 120 is fully tightened. When nut 120 is rotated in the loosening or counterclockwise direction, either by vibration or deliberately, cam surfaces 130 of nut 120 slide up cam surfaces 160 of washer 150 and nut 120 moves to a wedged, locked position between cam surfaces 160 of washer 120 and threads 128 in bore 145 of nut 120. As cam surfaces 130 of nut 120 slide up corresponding cam surfaces 160 of washer 150, cam surfaces 130 of nut 120 are in common sliding contact with cam surfaces 160 of washer 150 on contact planes that are inclined at a contact angle 47 relative to imaginary radial plane 17 orientated normal to rotational axis 16, and the contact angle 47 is greater than the pitch angle 49 of threads 128 in bore 145 of nut 120. Lock action may also be enhanced by the fact that the axial ridge height dimensions are less than the thread pitch distance of threads 128 of nut 120.

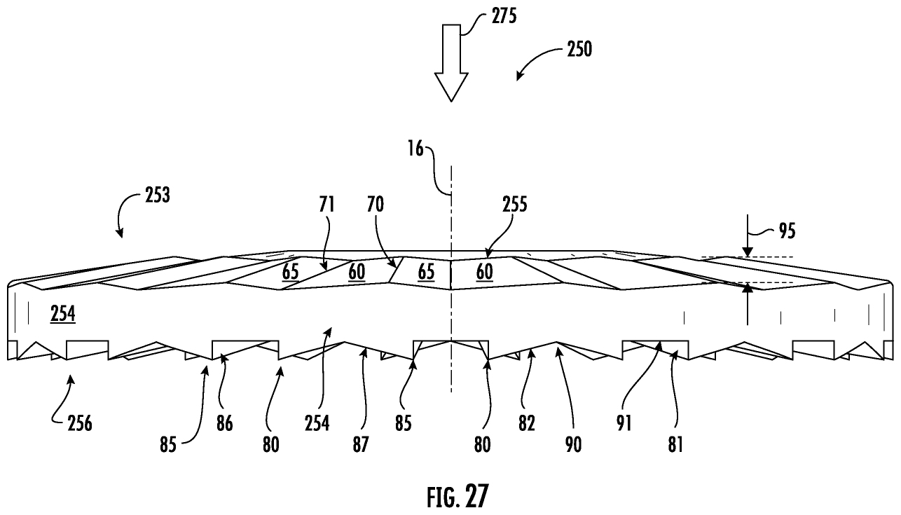

Turning now to FIG. 27, a conical-type washer 250 according to a third example embodiment is shown. Washer 250 is similar to the above-described washer 50 with respect to upper cam face 253 and lower work piece engaging face 256 of washer 250. However, in this embodiment, outer washer peripheral edge 254 of washer 250 is axially offset downwards from inner washer peripheral edge 255 by axial offset 95. As shown, with offset 95, washer 250 has a conical form prior to an applied load. When axially loaded by tightening of the associated bolt 20 or nut 120 in the direction 275, washer 250 will tend to elastically deform and deflect towards a flattened non-conical form, which provides an added internal locking stress force.

While forms of the fastener assembly have been shown and described, and several modifications discussed, persons skilled in this art will readily appreciate that various additional changes may be made. For example, the materials of construction are not deemed to be critical and may be changed or varied. For example, work piece 18 may be any metallic or non-metallic material and may be any member, sheet, or structure to which other members, sheets or structures may be fastened.

It should also be appreciated that certain features of the system, which are, for clarity, described in the context of separate embodiments, may also be provided in combination in a single embodiment. Conversely, various features, which are, for brevity, described in the context of a single embodiment, may also be provided separately or in any suitable combination. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. A fastener assembly comprising:
an elongated fastener body orientated about a rotational axis;
said fastener body having a threaded section orientated about said rotational axis;
said fastener body having an externally and radially extending bearing portion operatively configured to be axially retained by a work surface;
said bearing portion having an inner head surface, an outer head peripheral edge, and an inner head peripheral edge;
an annular lock washer operatively configured to move axially and rotationally relative to said bearing portion and to be positioned between said inner head surface of said bearing portion and said work surface;
said annular lock washer having an inner washer surface, an outer washer peripheral edge, an inner washer peripheral edge, and an outer washer surface;
said inner washer surface comprising a plurality of circumferentially spaced washer cam surfaces extending radially between said inner washer peripheral edge and said outer washer peripheral edge;
each of said washer cam surfaces being inclined relative to an imaginary plane orientated normal to said rotational axis from a lower washer cam edge to an upper washer cam edge within a washer cam radial angle;
said inner washer surface comprising a plurality of circumferentially spaced washer slip surfaces extending radially between said inner washer peripheral edge and said outer washer peripheral edge;
each of said washer slip surfaces being inclined relative to said imaginary plane orientated normal to said rotational axis from a lower washer slip edge to an upper washer slip edge within a washer slip radial angle;
said plurality of circumferentially spaced washer cam surfaces alternating circumferentially about said rotational axis with said plurality of circumferentially spaced washer slip surfaces;
each of said washer cam surfaces intersecting with two adjacent washer slip surfaces at a radial washer ridge defined by said upper washer cam edge of said washer cam surface and said upper washer slip edge of a first of said two adjacent washer slip surfaces and a radial washer valley defined by said lower washer cam edge of said washer cam surface and said lower washer slip edge of a second of said two adjacent washer slip surfaces;
said washer cam radial angle being greater than said washer slip radial angle;
said washer cam surface and said washer slip surface having a washer radial angle ratio between said washer cam radial angle and said washer slip radial angle that is less than or equal to about 4.5; and
said radial washer ridge having a ridge height normal to said imaginary plane and relative to said radial washer valley that is greater than or equal to about 0.08 mm.

2. The fastener assembly set forth in claim 1, wherein:
said inner head surface comprising a plurality of circumferentially spaced head cam surfaces extending radially between said inner head peripheral edge and said outer head peripheral edge;
each of said head cam surfaces being inclined relative to said imaginary plane orientated normal to said rotational axis from a lower head cam edge to an upper head cam edge within a head cam radial angle;
said inner head surface comprising a plurality of circumferentially spaced head slip surfaces extending radially between said inner head peripheral edge and said outer head peripheral edge;
each of said head slip surfaces being inclined relative to said imaginary plane orientated normal to said rotational axis from a lower head slip edge to an upper head slip edge within a head slip radial angle;
said plurality of circumferentially spaced head cam surfaces alternating circumferentially about said rotational axis with said plurality of circumferentially spaced head slip surfaces;
each of said head cam surfaces intersecting with two adjacent head slip surfaces at a radial head ridge defined by said upper head cam edge of said head cam surface and said upper head slip edge of a first of said two adjacent head slip surfaces and a radial head valley defined by said lower head cam edge of said head cam surface and said lower head slip edge of a second of said two adjacent head slip surfaces;
said head cam radial angle being greater than said head slip radial angle;
said head cam surface and said head slip surface having a head radial angle ratio between said head cam radial angle and said head slip radial angle that is less than or equal to about 4.5; and
said radial head ridge having a ridge height normal to said imaginary plane and relative to said radial head valley that is greater than or equal to about 0.08 mm.

3. The fastener assembly set forth in claim 2, wherein said washer cam radial angle and said head cam radial angle are substantially equal.

4. The fastener assembly set forth in claim 3, wherein said washer slip radial angle and said head slip radial angle are substantially equal.

5. The fastener assembly set forth in claim 1, wherein:
said outer washer surface comprising a plurality of circumferentially spaced first teeth operatively configured to resist rotation of said washer in a first rotational direction about said rotational axis relative to said work surface under an applied axial load; and
said outer washer surface comprising a plurality of circumferentially spaced second teeth operatively configured to resist rotation of said washer in a second rotational direction about said rotational axis relative to said work surface under an applied axial load.

6. The fastener assembly set forth in claim 5, wherein:
said plurality of circumferentially spaced first teeth extend radially between said inner washer peripheral edge and said outer washer peripheral edge; and
said plurality of circumferentially spaced second teeth extend radially between said inner washer peripheral edge and said outer washer peripheral edge.

7. The fastener assembly set forth in claim 6, wherein:
each of said plurality of circumferentially spaced first teeth comprise a first bite edge surface orientated perpendicular to said imaginary plane orientated normal to said rotational axis;
each of said plurality of circumferentially spaced first teeth comprise a first back surface being inclined relative to said imaginary plane orientated normal to said rotational axis within a first back radial angle and intersecting said first bite edge surface;
each of said plurality of circumferentially spaced second teeth comprise a second bite edge surface orientated perpendicular to said imaginary plane orientated normal to said rotational axis;
each of said plurality of circumferentially spaced second teeth comprise a second back surface being inclined relative to said imaginary plane orientated normal to said rotational axis within a second back radial angle and intersecting said second bite edge surface;
said plurality of circumferentially spaced first teeth alternating circumferentially about said rotational axis with said plurality of circumferentially spaced second teeth;
each of said first back surfaces of said first plurality of circumferentially spaced first teeth intersecting with an adjacent second back surface of said second plurality of circumferentially spaced second teeth at a radial back valley; and
each of said first bite edge surfaces of said first plurality of circumferentially spaced first teeth separated from an adjacent second bite edge surface of said second plurality of circumferentially spaced second teeth by a radial bite valley surface within an opposed bite edge radial angle.

8. The fastener assembly set forth in claim 1, wherein said fastener body is in the form of a bolt and comprising:
a head portion having an outer head surface and comprising said inner bearing portion;
a shank portion extending axially from said inner head peripheral edge of said inner bearing portion and operatively configured to extend through said work surface;
said shank portion comprising said threaded section, which is orientated externally about said rotational axis; and
said annular lock washer operatively configured to receive said shank portion of said fastener body.

9. The fastener assembly set forth in claim 1, wherein said fastener body is in the form of a nut and comprising:
a head portion having an outer head surface and comprising said inner bearing portion;
a washer retaining portion extending axially from said inner head peripheral edge of said inner bearing portion;
said head portion comprising said threaded section, which is orientated internally about said rotational axis; and
said annular lock washer operatively configured to receive said washer retaining portion of said fastener body.

10. The fastener assembly set forth in claim 9, wherein a portion of said washer retaining portion is crimped over a portion of said outer washer surface.

11. The fastener assembly set forth in claim 1, wherein said outer washer peripheral edge of said annular lock washer is axially offset from said inner washer peripheral edge of said annular lock washer, whereby said annular lock washer has a conical form prior to an applied axial load.

12. The fastener assembly set forth in claim 2, wherein:
said threaded section of said fastener body has a thread having a pitch angle;
each of said head cam surfaces are operatively configured to be in sliding contact with one of each of said washer cam surfaces, within an angular range of relative rotational motion about said rotational axis, on contact planes that are each inclined at a contact angle relative to said imaginary plane; and
each contact angle is greater than said pitch angle.

13. The fastener assembly set forth in claim 12, wherein said angular range of relative rotational motion about said rotational axis is substantially equal to said washer cam radial angle.

14. The fastener assembly set forth in claim 12, wherein said thread of said threaded section of said fastener body has a pitch distance and said ridge height of said radial washer ridge is less than said pitch distance.
